(19) United States
(12) Patent Application Publication
(10) Pub. No.: US 2026/0352588 A1
(43) Pub. Date: Nov. 5, 2026

(54) METHODS FOR BORDER GATEWAY PROTOCOL AUTO-RECOVERY

(71) Applicant: Cisco Technology, Inc., San Jose, CA (US)

(72) Inventors: Jakob Heitz, Santa Clara, CA (US); Mankamana Prasad Mishra, San Jose, CA (US); Sameer R. Gulrajani, Fremont, CA (US); Swadesh Agrawal, San Jose, CA (US)

(21) Appl. No.: 19/194,740

(22) Filed: Apr. 30, 2025

(51) Int. Cl. H04L 45/02; H04L 45/44; H04L 45/748

(52) U.S. Cl. CPC H04L 45/04; H04L 45/44; H04L 45/748

(57) ABSTRACT

A method is performed by a router configured to implement a Border Gateway Protocol (BGP) with a peer router across one or more networks. The method comprises: importing first peer route prefixes that are advertised by the peer router into a prefix table configured with a prefix limit; tracking a number of the first peer route prefixes that are imported; upon determining that the number exceeds the prefix limit, sending, to the peer router, a count route refresh that solicits, from the peer router a count of second peer route prefixes that are held by the peer router for the router, but not the second peer route prefixes themselves; receiving the count from the peer router; and upon determining that the count is less than the prefix limit, sending, to the peer router, a route refresh for the second peer route prefixes.

### TECHNICAL FIELD

The present disclosure relates to auto-recovery techniques for the Border Gateway Protocol (BGP).

### BACKGROUND

The Border Gateway Protocol (BGP) exchanges routing information between routers of autonomous systems (ASs). The routing information includes advertisements of route prefixes used to route traffic along network paths. Each router stores the route prefixes in a BGP table (e.g., a routing information base (RIB)) and a forwarding table (e.g., a forwarding information base (FIB)) used by the routers to forward the traffic. Under certain conditions, the routers may receive unexpectedly large numbers of advertisements over a short period of time, which can overwhelm resources of the routers and cause them to drop valid route prefixes. Additionally, certain events may trigger the routers to withdraw from their BGP tables large numbers of valid route prefixes that should not be withdrawn. Widespread simultaneous occurrences of the aforementioned conditions/events can cause a “BGP outage” during which the BGP stops working properly, leaving the routers without peer reachability information, and rendering the routers unable to forward traffic. The BGP outage seriously interrupts normal traffic flow within and across networks, such as the Internet. Recovery from the BGP outage often involves manual reconfiguration of individual routers. Given the many thousands of routers in a network, such manual intervention is labor intensive, time consuming, and can be impractical.

### BRIEF DESCRIPTION OF THE DRAWINGS

FIG. 1 is a block diagram of a network environment in which embodiments directed to BGP auto-recovery may be implemented, according to an example embodiment.

FIG. 2 is a flowchart of a method of BGP auto-recovery performed by/between peer routers of the network environment using a count route refresh message, according to an example embodiment.

FIG. 3 is an illustration of an example initial configuration for one of the peer routers prior to the BGP auto-recovery, according to an example embodiment.

FIG. 4 is an illustration of example transactions for the BGP auto-recovery triggered by an excessive number of prefixes advertised between the peer routers, according to an example embodiment.

FIG. 5 is an illustration of the count route refresh message, according to an example embodiment.

FIG. 6 shows classifications of prefixes into a high priority prefix range and multiple low priority prefix ranges, according to an example embodiment.

FIG. 7 is a block diagram of an example network environment in which BGP auto-recovery using a BGP monitoring protocol (BMP) may be implemented, according to an example embodiment.

FIG. 8 is a flowchart of a method performed by a network controller of FIG. 7 to implement BGP auto-recovery using BGP prefix information gained through the BMP, according to an example embodiment.

FIG. 9 is a block diagram of a network in which router out-of-resource (OOR) auto-recovery may be performed, according to an example embodiment.

FIG. 10 is a flowchart of a method performed by a router to implement the OOR auto-recovery, according to an example embodiment.

FIG. 11 is an illustration of a trial route refresh message, according to an example embodiment.

FIG. 12 is a flowchart of a method performed by a router to implement BGP auto-recovery with respect to a peer router using the count route refresh method, according to an example embodiment.

FIG. 13 is a flowchart of a method performed by a network controller to implement BGP auto-recovery between a first router and a second router that are BGP peers, and BMP clients to a BMP server, in one or more networks, according to an example embodiment.

FIG. 14 is a flowchart of a method performed by a router to implement OOR auto-recovery, according to an example embodiment.

FIG. 15 illustrates a hardware block diagram of a computing device that may perform operations to implement the embodiments presented herein, according to an example embodiment.

### DESCRIPTION OF EXAMPLE EMBODIMENTS

### Overview

In a first embodiment, a method is performed by a router configured to implement a Border Gateway Protocol (BGP) with a peer router across one or more networks. The method comprises: importing first peer route prefixes that are advertised by the peer router into a prefix table configured with a prefix limit; tracking a number of the first peer route prefixes that are imported; upon determining that the number exceeds the prefix limit, sending, to the peer router, a count route refresh that solicits, from the peer router a count of second peer route prefixes that are held by the peer router for the router, but not the second peer route prefixes themselves; receiving the count from the peer router; and upon determining that the count is less than the prefix limit, sending, to the peer router, a route refresh for the second peer route prefixes.

In a second embodiment, a method is performed by a network controller of a first router and a second router that operate as routing peers in one or more networks. The method comprises: tracking a first number of first route prefixes advertised by the second router and imported into a first prefix table of the first router that is configured with a prefix limit; tracking a second number of second route prefixes held by the second router for the first router; upon determining that the first number of first route prefixes exceeds the prefix limit, determining whether there is space available in the first prefix table for the second route prefixes; and when there is the space available, commanding the first router to send a route refresh to the second router to cause the second router to send the second route prefixes to the first router.

In a third embodiment, a method is performed by a router in a network. The method includes: upon receiving routes advertised by peer routers, performing route processing of the routes that includes importing the routes into a routing table, and pushing the routes from the routing table to a forwarding table used to forward traffic; and upon detecting an out-of-resource condition that cause the routes that are received to be dropped, performing route recovery to include: sending to each peer router a trial route refresh to solicit peer routes stored in each peer router; upon receiving the peer routes from each peer router, performing trial route processing that includes importing the peer routes into a trial routing table; and upon determining that the forwarding table has available space to accommodate the peer routes in the trial routing table, pushing the peer routes to the forwarding table.

### Example Embodiments

For a router that implements a routing protocol (such as a Border Gateway Protocol (BGP)), embodiments presented herein detect a condition of the router that can cause the router to drop route advertisements (e.g., route prefixes) from peer routers. Upon detecting the condition, the embodiments perform route auto-recovery (e.g., BGP auto-recovery) to recover dropped or missing routes from the peer routers, automatically. The route auto-recovery prevents, or recovers quickly, from a BGP outage, for example.

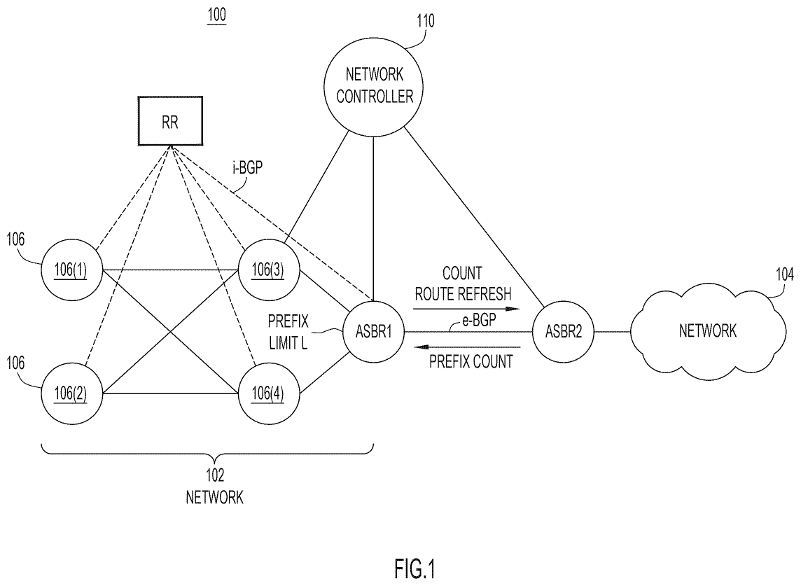

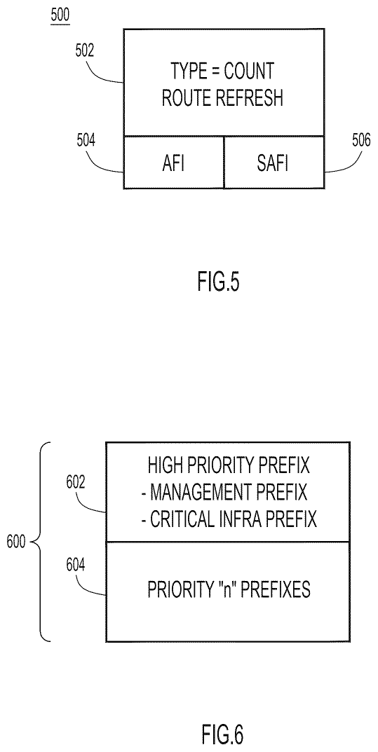

In a first embodiment, a router performs route auto-recovery using a count route refresh message that solicits a count of routes held by the peer routers. In a second embodiment, a network controller employs a BGP monitoring protocol (BMP) to determine route statistics for peer routers that serve as BMP clients, and triggers route auto-recovery based on the statistics. In a third embodiment, a router detects an out-of-resource (OOR) condition of the router, which triggers route auto-recovery. In the ensuing description, the first embodiment is described in connection with FIGS. 1-6 and 12, the second embodiment is described in connection with FIGS. 6-8 and 13, and the third embodiment is described in connection with FIGS. 9-11 and 14.

With reference to FIG. 1, there is a block diagram of an example network environment 100 in which the embodiments of route auto-recovery (e.g., BGP auto-recovery) may be implemented. Network environment 100 includes a network 102 (e.g., a first autonomous system (AS)) and a network 104 (e.g., a second AS). Network 102 includes routers 106(1)-106(4) (collectively referred to as “routers 106”), an autonomous system border router (ASBR) ASBR1, and a route reflector (RR) that communicate with each other over network links. As used herein, the term “router” means any network device configured to perform network routing and/or switching, and which may be implemented in hardware and/or as an application that executes on a computer platform, for example.

Routers 106 reside internally within network 102, while router ASBR1 resides on a border of the network, and serves as the ASBR for the network. Routers 106 and ASBR1 represent peer routers within network 102. Similarly, network 104 includes internal routers (not shown) and a router ASBR2 that communicate with each other. Router ASBR2 serves as the ASBR for network 104. Networks 102 and 104 communicate with each other through/via routers ASBR1 and ASBR2. Routers ASBR1 and ASBR2 are inter-network peers, i.e., ASBR peers. Routers ASBR1 and ASBR2 may be referred to simply as “ASBR1” and “ASBR2,” respectively. Network environment 100 also includes a network controller 110 configured to communicate with and control the routers of networks 102 and 104 over various communication links. In the example, network controller 110 is separate from the routers and generally operates as an independent entity, except to exert control over the routers as described below.

The routers of networks 102 and 104 implement various forms of a BGP (more generally, a “routing protocol”) by which the routers learn BGP routes from their peer routers. A BGP route includes a route prefix and its attributes. A route prefix may be an Internet Protocol (IP) version (v) 4 (IPv4) prefix (e.g., 192.168.1.0/24) or an IPv6 prefix (e.g., 2001:db8:1234:5678:90ab:cdef:1234:5678/64), for example. The routers originate BGP advertisements, which advertise the route prefixes to peer routers. Routers 106 and ASBR1 of network 102 collectively implement internal-BGP (i-BGP) by which the routers learn route prefixes (within the network) via the BGP advertisements. Router reflector RR disseminates the BGP advertisements among routers 106 and ASBR1. Similarly, the internal routers of network 104 and ASBR2 employ i-BGP to advertise their route prefixes to one another. Routers ASBR1 and ASBR2 implement exterior-BGP (e-BGP) by which the ASBRs advertise their route prefixes to each other.

When a router receives a BGP advertisement from a peer router, which represents a next hop router relative to the router along a route, the router may import or store the advertised route prefix conveyed by the BGP advertisement into a BGP table (or multiple BGP tables) (also referred to as a “routing table,” and more specifically as a “routing information base (RIB)”). Alternatively, the router may simply drop or discard the route prefix, in which case the router does not import the route prefix into the BGP table. The router is configured with a maximum prefix limit (referred to simply as a “prefix limit” in the ensuing description) for a peer which represents a maximum number of route prefixes from the peer that are permitted to be imported/stored to the BGP table. The router also includes a forwarding information base (FIB). The FIB may be implemented in hardware, such as ternary content-addressable memories (TCAMs), for fast lookups. The router pushes certain route prefixes from the BGP table to the FIB. The router forwards traffic based on fast lookups of the route prefixes in the FIB. In the ensuing description, a “route prefix” may be referred to simply and interchangeably as a “prefix.”

The router may be configured with an inbound policy that filters prefixes received from a peer router. That is, the inbound policy controls which prefixes, when received, will be imported into the BGP table, and which will be dropped. A network administrator may provision the inbound policy on the router, which may remain inactive on the router until a certain event occurs, at which time the router activates the inbound policy. The inbound policy may prioritize prefix ranges to include a high priority prefix range and a low priority prefix range. A prefix in the high priority prefix range is considered a high priority prefix that should be imported, while a prefix in the low prefix range is considered a low priority prefix that should be dropped. The inbound policy controls/causes the router to import prefixes that are high priority prefixes, and drop prefixes that are low priority prefixes (i.e., that are not high priority prefixes).

The router may also be configured with an outbound policy that filters prefixes to be advertised by the router. That is, the outbound policy controls which of the prefixes held by the router will be advertised, and which prefixes will not be advertised. The outbound policy may prioritize prefix ranges to include a high priority prefix range and a low priority prefix range. A prefix in the high priority prefix range is considered a high priority prefix that should be advertised, while a prefix in the low prefix range is considered a low priority prefix that should not be advertised. Thus, the outbound policy controls (i.e., causes) the router to advertise (i.e., export) prefixes that are high priority prefixes, and to not advertise prefixes that are low priority prefixes.

In accordance with the BGP, the router (referred to as the “requesting router”) may send to a peer router a known BGP route refresh (also referred to simply as a “route refresh”). The route refresh is a message that solicits, from the peer router, all prefixes that the peer router has in its BGP table for the requesting router, which is a previous hop router to the peer router. When the peer router receives the route refresh from the requesting router, the peer router returns all of the prefixes that the peer router holds for the requesting router. This may be referred to as a “dump” of the BGP table from the peer router. For example, when ASBR1 sends a route refresh to ASBR2, ASBR2 returns to ASBR1 all prefixes (held by ASBR2) for ASBR1.

The first embodiment of route auto-recovery (e.g., BGP auto-recovery) extends or modifies conventional BGP to include or introduce an enhanced route refresh (referred to as a “count route refresh”) that may be sent by the router (i.e., the “requesting router”) to the peer router. The count route refresh is a message that solicits from the peer router a count (i.e., a number) of all prefixes (but not the actual prefixes) held by the peer router in its BGP table, for the router. For example, the count represents a number of prefixes that the peer router would return to the router responsive to a route refresh sent by the router. When the peer router receives the count route refresh, the peer router returns only the count of the prefixes (i.e., the prefix count), but not the actual prefixes themselves. For example, when ASBR1 sends a count route refresh to ASBR2, ASBR2 returns to ASBR1 only a count of the prefixes (held by ASBR2) for ASBR1.

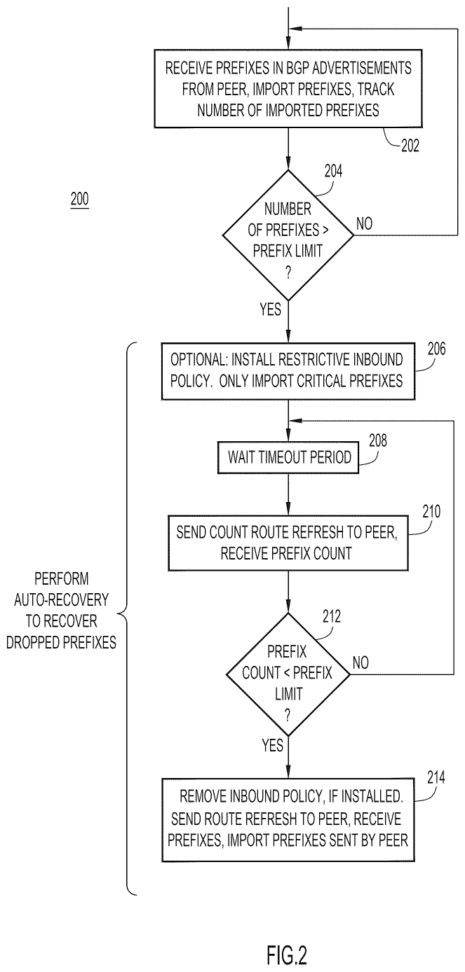

FIG. 2 is a flowchart of an example method 200 of BGP auto-recovery performed by/between ASBR1 and ASBR2 using the count route refresh.

At 202, ASBR1 does not have a restrictive inbound policy installed. ASBR1 is configured with a prefix limit for prefixes from ASBR2. ASBR1 receives prefixes (also referred to as “first peer prefixes”) advertised by ASBR2 (i.e., prefixes from ASBR2 toward ASBR1). ASBR1 performs BGP processing on the prefixes that results in importing the prefixes into a BGP table of ASBR1 that holds prefixes from ASBR2. The BGP processing may format the prefixes into a compressed form prior to importing the prefixes. ASBR1 tracks a number of the prefixes imported into the BGP table over time. The number (i.e., the number of imported prefixes) increases when the prefixes are imported to the BGP table, and decreases when ASBR1 withdraws or removes the prefixes from the BGP table. Operations performed at 202 repeat/continue over time as method 200 is performed.

At 204, ASBR1 determines whether the number exceeds (i.e., is greater than) the prefix limit. When the number does not exceed (i.e., is less than or equal to) the prefix limit, flow returns to 202. When the number exceeds the prefix limit, flow proceeds to 206. When the number exceeds the prefix limit, this indicates that ASBR1 may be dropping prefixes advertised by ASBR2. ASBR1 does not track which prefixes are dropped and which are not dropped. When the number exceeds the prefix limit, BGP auto-recovery is triggered to recover dropped prefixes from ASBR2. The BGP auto-recovery is described below.

At 206, ASBR1 optionally dynamically installs a restrictive inbound policy that filters prefixes subsequently received from/advertised by ASBR2. The inbound policy prioritizes prefix ranges into a critical (i.e., high priority) prefix range and a non-critical (i.e., low-priority) prefix range. A prefix in the critical prefix range is a critical prefix that should be imported, while a prefix in the non-critical prefix range is a non-critical prefix that should be dropped. ASBR1 executes the inbound policy on the BGP table to delete/remove/withdraw previously imported non-critical (i.e., low-priority) prefixes stored in the BGP table to make room for subsequently received critical (i.e., high-priority) prefixes. Then, based on the inbound policy, ASBR1 imports only the critical prefixes received from ASBR2 (assuming there is room in the BGP table), and drops the rest. Flow proceeds to 208.

At 208, ASBR1 waits a timeout period after which flow proceeds to 210. For example, ASBR1 starts a timer and, upon expiry of the timer, flow proceeds to 210. The timeout period provides time for the number of prefixes stored in the BGP table to drop below the prefix limit, which frees-up space in the BGP table for subsequent imported prefixes.

Next operations 210 and 212 collectively determine whether the BGP table in ASBR1 can accept a BGP table dump from ASBR2.

At 210, ASBR1 sends to ASBR2 a count route refresh that requests a count of prefixes (i.e., a prefix count) held by ASBR2 for ASBR1. The prefixes held by ASBR2 for ASBR1 may be referred to as “second peer prefixes.” The prefixes held by ASBR2 may overlap with the prefixes (i.e., the first peer prefixes mentioned above) advertised and imported at 202. Upon receiving the count route refresh, ASBR2 returns to ASBR1 the prefix count of prefixes (but no actual prefixes) held by ASBR2 for ASBR1. The prefix count represents the number of actual prefixes that ASBR2 would send to ASBR1 in the event that ASBR1 were to send a route refresh to ASBR2. Flow proceeds to 212.

At 212, ASBR1 determines whether the prefix count returned by ASBR2 exceeds the prefix limit. When the prefix count exceeds the prefix limit, flow returns to 208. When the prefix count does not exceed the prefix limit, flow proceeds to 214, for prefix recovery.

At 214, ASBR1 removes its restrictive inbound policy (if installed at 206). ASBR1 sends to ASBR2 a route refresh. Upon receiving the route refresh, ASBR2 returns to ASBR1 all prefixes held by ASBR2 for ASBR2 (some of which may have been dropped when previously advertised to ASBR1). ASBR1 imports the prefixes returned by ASBR2.

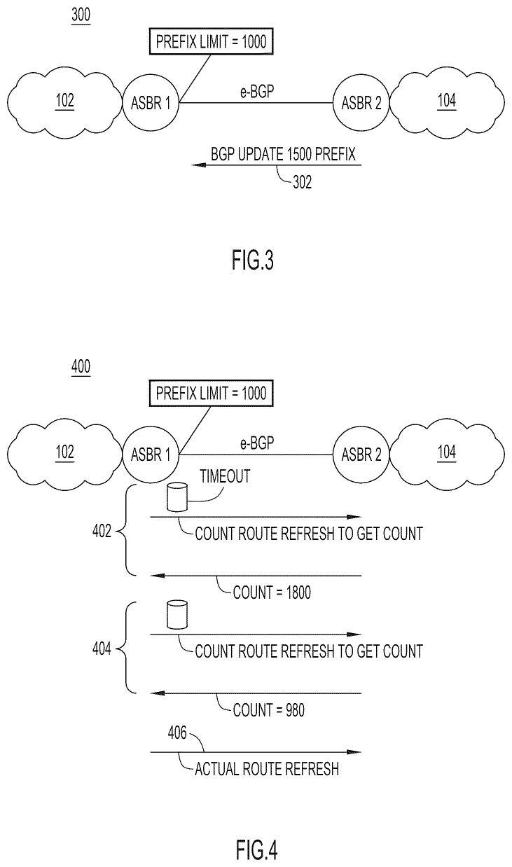

An illustration of method 200 performed between ASBR1 and ASBR2 is described below with reference to FIGS. 3 and 4.

FIG. 3 is an illustration of an example initial configuration 300 for ASBR1, prior to BGP auto-recovery. In the initial configuration, ASBR1 is configured with a prefix limit=1000. At 302, ASBR2 sends to ASBR1 BGP updates that include 1500 prefixes, which exceeds the prefix limit=1000. Responsive to the excessive number of prefixes, ASBR1 drops the received prefixes. ASBR1 may install a restrictive inbound policy and thereafter import only critical prefixes into the BGP table at ASBR1, when/if the same has room/space available. The excessive number of prefixes triggers BGP auto-recovery in ASBR1, as shown in FIG. 4.

FIG. 4 is an illustration of example BGP auto-recovery transactions 400 for BGP auto-recovery triggered by the excessive number of prefixes advertised to ASBR1 by ASBR2 in initial configuration 300 of FIG. 3. At 402, ASBR1 starts a timeout period. Upon expiry of the timeout period, ASBR1 sends to ASBR2 a count route refresh (i.e., an enhanced route refresh) that requests a count of prefixes held by ASBR2 in its BGP table for/toward ASBR1. After sending the count route refresh, ASBR2 sends to ASBR1, and ASBR1 receives, a prefix count =1800. That is, ASBR2 has 1800 prefixes for ASBR1.

Responsive to receiving the prefix count=1800 that exceeds the prefix limit=1000, at 404, ASBR1 again starts the timeout period, continues to drop prefixes, and maintains the restrictive inbound policy. Upon expiry of the timeout period, ASBR1 sends to ASBR2 another count route refresh. In response, ASBR1 receives from ASBR2 a prefix count=980. Because the prefix count=980 is less than the prefix limit, ASBR1 removes the restrictive inbound policy. At 406, ASBR1 sends to ASBR2 a route refresh to solicit from ASBR2 all prefixes held by ASBR2 for ASBR1. In response, ASBR2 sends to ASBR1 all prefixes for ASBR1.

FIG. 5 is an illustration of a count route refresh 500. Count route refresh 500 includes a type field 502 (e.g., a predetermined message subtype value, such as value=3) to indicate/define the count route refresh, an address family identifier (AFI) 504 to indicate a network layer protocol (e.g., IPv4, IPv6), and a subsequent address family identifier (SAFI) 506 to indicate network layer reachability information (e.g., unicast, multicast, and so on).

FIG. 6 shows classifications of prefixes 600 into a high priority prefix range 602 and multiple (n) lower priority prefix ranges 604. High priority prefixes relate to management and critical infrastructure prefixes, for example.

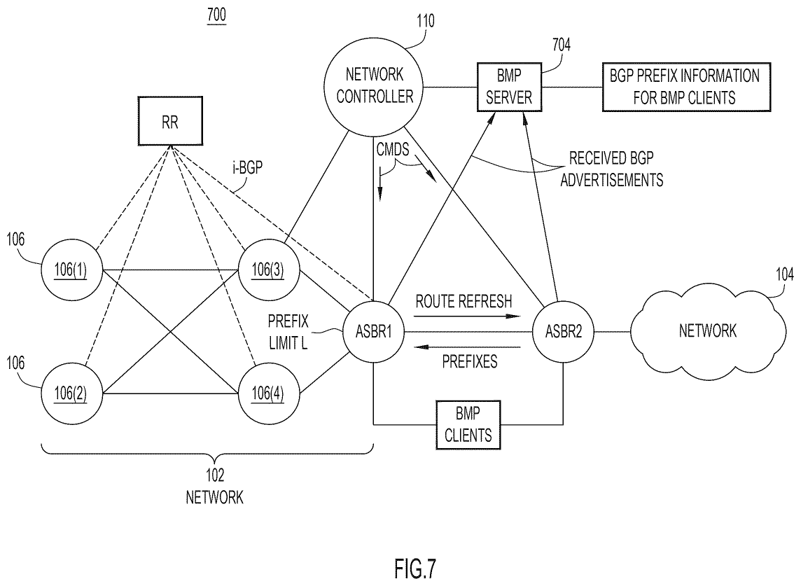

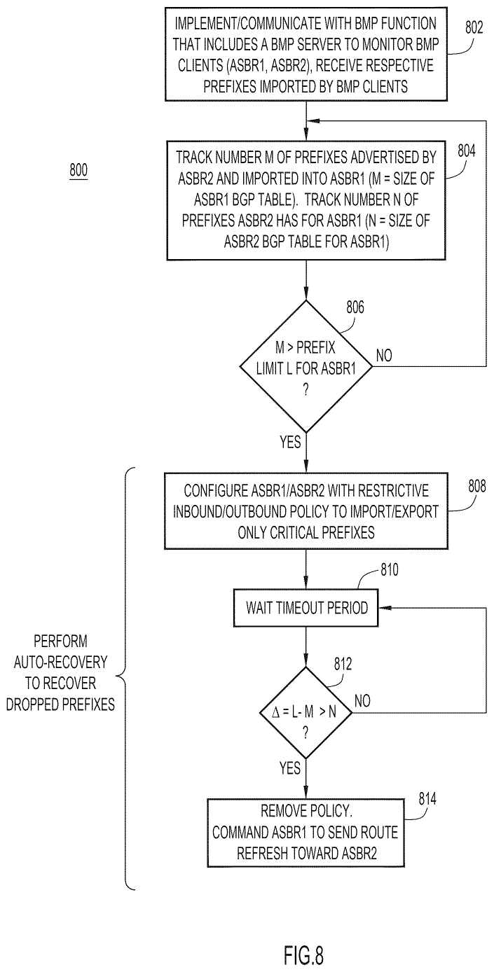

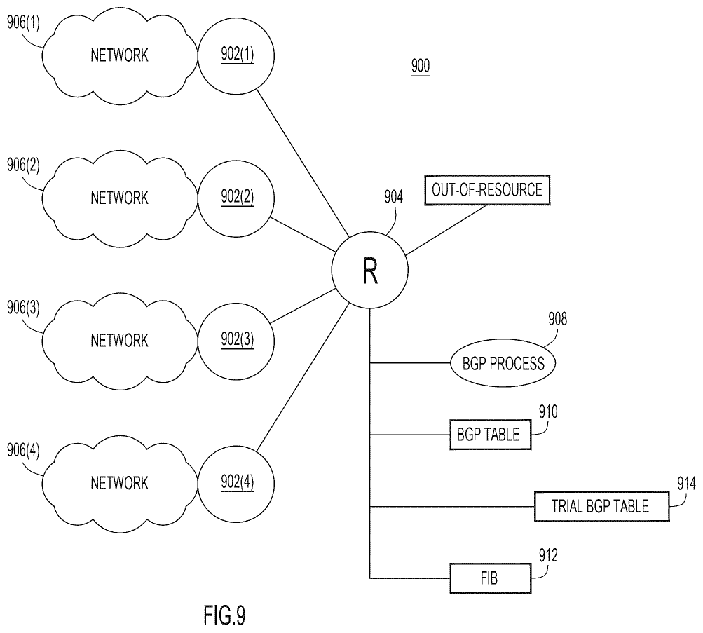

FIG. 7 is a block diagram of an example network environment 700 configured to implement the second embodiment of BGP auto-recovery that uses a BMP. Network environment 700 is similar to network environment 100, except for differences described below. Network environment 700 includes network controller 110 to communicate with and control the routers of network 102 and 104, including ASBR1 and ASBR2. For example, network controller may send commands (CMDS) to ASBR1 and ASBR2 to cause them to perform certain actions, described below. In addition, network controller 110 implements or communicates with (i.e., “accesses”) functions of the BMP.

In the example, the BMP employs a BMP server 704 configured to monitor BMP clients, including routers ASBR1 and ASBR2. In the example, BMP server 704 may be integrated with network controller 110. In another example, BMP server 704 is separate from network controller 110 and communicates with the network controller over a communication link. Either way, network controller 110 is able to access complete and current BGP prefix information for BMP clients ASBR1 and ASBR2 that is held by BMP server 704.

According to the BMP, on an ongoing basis, each BMP client (e.g., ASBR1 and ASBR) notifies BMP server 704 of all prefixes received from, and advertised to, all peers. Therefore, BMP server 704 receives from each BMP client the prefixes received by each BMP client from its peers. BMP server 704 may also request that each BMP client send to the BMP server the contents of each BGP table, e.g., to perform a BGP table dump to the BMP sever. In this way, BMP server 704 has a view of the contents of each BGP table in each BMP client. Moreover, network controller 110 has access to the BGP prefix information held by BMP server 704. Network controller 110 implements BGP auto-recovery using the BGP prefix information held by BMP server 704, as described below in connection with FIG. 8.

FIG. 8 is a flowchart of an example method 800 performed primarily by network controller 110 to implement BGP auto-recovery using BGP prefix information for peer routers that serve as BMP clients of a BMP server. Network controller 110 accesses the BGP prefix information via the BMP server.

At 802, network controller 110 implements or communicates with a BMP function that includes BMP server 704 configured to monitor BMP clients, including ASBR1 and ASBR2. BMP server 704 receives BGP advertisements (and thus prefixes) received by each BMP client over time. BMP server 704 builds BGP prefix information that reflects the contents of the BGP tables of ASBR1 and ASBR2 based on monitoring the BMP clients (e.g., ASBR1 and ASBR2). Network controller 110 repeatedly accesses the BGP prefix information. Flow proceeds to 804.

At 804, network controller 110 generates various prefix-based statistics based on the BGP prefix information. First, network controller 110 tracks a number M (e.g., a first number) of prefixes (e.g., of first prefixes) advertised by ASBR2 to ASBR1 and that are imported by ASBR1 into the BGP table of ASBR1; essentially, M=ASBR1 BGP table size. The number M may increase and decrease over time as ASBR1 imports routes advertised by ASBR2, and withdraws routes from the BGP table in ASBR1, respectively. Second, network controller 110 tracks a number N (e.g., a second number) of prefixes (e.g., of second prefixes) that ASBR2 has stored in its BGP table for ASBR1; essentially, N=ASBR2 BGP table size directed to ASBR1. The number N may increase and decrease over time as ASBR2 adds prefixes and withdraws prefixes toward ASBR1, respectively. Flow proceeds to 806.

At 806, network controller 110 determines whether the number M of prefixes imported by ASBR1 (i.e., the size of the ASBR1 BGP table) exceeds the prefix limit L for the BGP table of ASBR1 (i.e., is M>L?). When M does not exceed L, flow returns to 804. When M exceeds L, flow proceeds to 808. When M exceeds L, ASBR1 may be dropping prefixes for ASBR1 advertised by ASBR2. When M exceeds L, BGP auto-recovery is triggered, as described below.

At 808, network controller 110 optionally configures ASBR1 with a restrictive inbound policy toward ASBR2 that operates similarly to the inbound policy described above in connection with 206 of FIG. 2. For example, network controller 110 sends to ASBR1 a command that causes the router to install the inbound policy, which runs over the BGP table of ASBR1 as described above, and then filters importation of prefixes advertised by ASBR2. Alternatively, network controller 110 optionally configures ASBR2 with a restrictive outbound policy toward ASBR1, similar to that described above in connection with FIG. 1. For example, network controller 110 sends to ASBR2 a command that causes the router to install the outbound policy. Flow proceeds to 810.

At 810, ASBR1 waits a timeout period after which flow proceeds to 812. The timeout period gives ASBR1 time to reduce the size of its BGP table, possibly.

At 812, network controller 110 computes/tracks how much space is available in the ASBR1 BGP table to import prefixes advertised by ASBR2. To do this, network controller 110 computes a difference Δ between the prefix limit L and the number M of prefixes that ASBR1 has imported from ASBR2 (i.e., difference Δ=L−M). The difference Δ represents the available space in the ASBR1 BGP table. Next, network controller 110 determines whether the ASBR1 BGP table has sufficient available space (available space Δ=L−M) to accept all N prefixes that ASBR2 has for ASBR1 in the BGP table of ASBR2 (i.e., does the ASBR1 BGP table have sufficient available space Δ to accommodate the N prefixes for ASBR1 that are being held by ASBR2?).

To do this, network controller 110 determines whether the available space Δ exceeds N (i.e., is Δ>N?). When the available space Δ does not exceed N (which means that the ASBR1 BGP table does not have sufficient room to import prefixes from ASBR 2), flow returns to 810, and network controller 110 repeats the timeout period. On the other hand, when the available space Δ exceeds N (which means there is sufficient available space in the ASBR1 BGP table to accommodate/import all N prefixes from ASBR2), flow proceeds to 814.

At 814, network controller 110 commands ASBR1/ASBR2 to remove any restrictive inbound/outbound policy that may have been installed at 808. Then, network controller 110 commands ASBR1 to send a route refresh to ASBR2. Responsive to the command, ASBR1 sends the route refresh to ASBR2. Upon receiving the route refresh, ASBR2 sends to ASBR1 all N prefixes for ASBR1 stored in the ASBR2 BGP table. ASBR1 imports the prefixes into the BGP table of ASBR1.

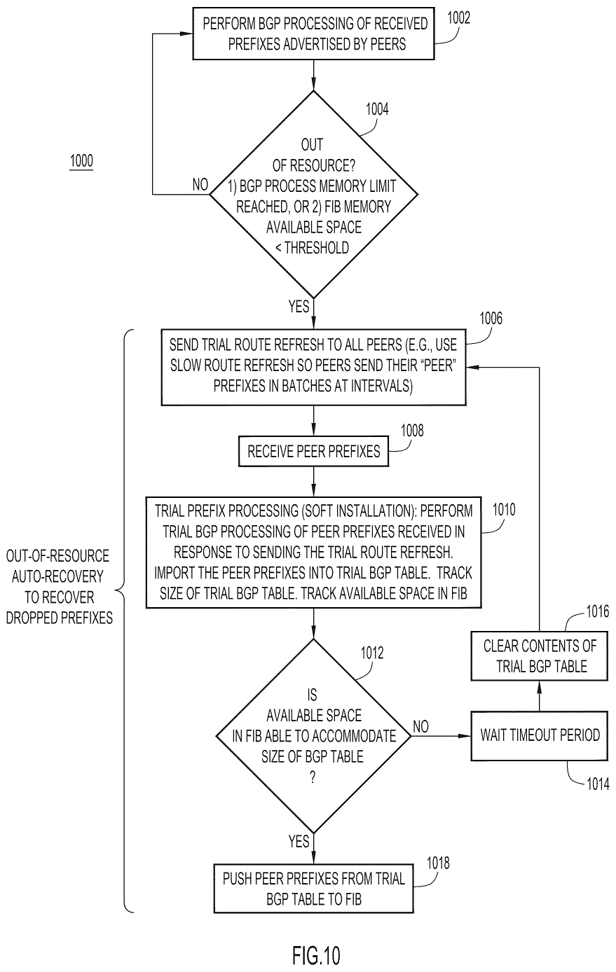

FIG. 9 is a block diagram of an example network 900 in which an embodiment directed to router out-of-resource (OOR) (route) auto-recovery may be performed. Network 900 includes routers 902(1)-902(4) and a router 904 connected to each other. Routers 902(1)-902(4) may be connected to respective networks 906(1)-906(4). Routers 902(1)-902(4) and router 904 are BGP peers that implement the BGP. Router 904 includes a BGP process 908, a BGP table 910, and a FIB 912, collectively referred to as “resources” of the router. Router 904 also includes a trial BGP table 914 (also referred to as a “temporary BGP table”). Router 904 performs OOR auto-recovery (also referred to as “OOR route auto-recovery”) described below in connection with FIG. 10. In network 900, in one scenario, peer routers 902(1)-902(4) may advertise the same prefix four times. In another scenario, the peer routers may advertise four different prefixes. Thus, the amount of BGP table memory used to store the imported prefixes differs in each case due to de-duplication of prefixes and other processing. The OOR auto-recovery operates equally well for each case.

FIG. 10 is a flowchart of an example method 1000 performed by router 904 to implement the OOR auto-recovery. FIG. 10 is described with continued reference to FIG. 9.

At 1002, router 904 receives prefixes advertised by peer routers 902(1)-902(4) (referred to as “peer routers”). Router 904 performs route processing (which includes BGP processing) on the prefixes, which imports the prefixes into BGP table 910. The route processing performs de-duplication of the prefixes across the peer routers, among other operations. The route processing pushes (i.e., stores copies or compressed versions of) prefixes stored in BGP table 910 to FIB 912. Router 904 uses the prefixes stored in FIB 912 to forward traffic.

At 1004, router 904 determines whether a router OOR condition is met (i.e., is detected). For example, router 904 determines whether any of a prefix limit for BGP table 910 has been reached, a memory limit for the route processing (including for BGP process 908) has been reached, or available space in FIB 912 has fallen below a threshold. When the router OOR condition is not met, flow returns to 1002. When the router OOR condition is met, flow proceeds to 1006. When the condition is met, router 904 may begin dropping prefixes received from the peer routers. Auto-recovery begins at 1006.

At 1006, router 904 sends to each peer router a trial route refresh to solicit peer prefixes (i.e., peer routes) stored in each peer router for router 904 (i.e., to solicit a dump of a BGP table from each peer router). In an example, the trial route refresh may be configured as a “slow” route refresh. The slow route refresh represents an extension or modification to the conventional BGP. Upon receiving the slow route refresh, each peer router sends to router 904, at spaced-apart time intervals, successive batches (or subsets) of prefixes from the respective BGP table, to avoid overwhelming the router with inbound prefixes all at once. Alternatively, the trial route refresh may be a conventional route refresh. Flow proceeds to 1008.

Responsive to sending the trial route refresh to each peer router, at 1008, router 904 receives the peer prefixes from each peer router. Flow proceeds to 1010.

At 1010, router 904 performs “trial” BGP processing on the peer prefixes. The trial BGP processing performs normal BGP processing of the peer prefixes, except that the trial BGP processing imports the peer prefixes (once processed) into trial BGP table 914, not BGP table 910. This may be referred to as “soft installation.” As the peer prefixes are imported into trial BGP table 914, router 904 tracks the size of the trial BGP table. Router 904 also tracks the size of the available space in FIB 912. The sizes may be in units of bytes, for example. Flow proceeds to 1012.

At 1012, router 904 compares the size of trial BGP table 914 to (the size of) the available space in FIB 912 to determine whether there is sufficient available space in the FIB to accommodate all of the peer prefixes in the trial BGP table. When there is insufficient available space in FIB 912 (e.g., the available space is less than the size of trial BGP table 914), flow proceeds to 1014. At 1014, router 904 waits a timeout period and then flow proceeds to 1016. At 1016, router 904 clears or resets trial BGP table 914, and flow returns to 1006 to repeat route recovery. The timeout period gives the router time to clear or remove the OOR condition that triggered the route recovery. On the other hand, when there is sufficient available space in FIB 912 (e.g., the available space is greater than or equal to the size of trial BGP table 914), flow proceeds to 1018.

At 1018, router 904 pushes all the peer prefixes from trial BGP table 914 to FIB 912.

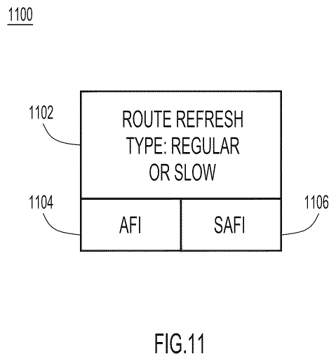

FIG. 11 is an illustration of an example trial route refresh 1100. Trial route refresh 1100 includes a type field 1102 with a first value to define “slow” route refresh, or a second value to define normal or conventional route refresh. Trial route refresh 1100 also includes an AFI 1104 and a SAFI 1106.

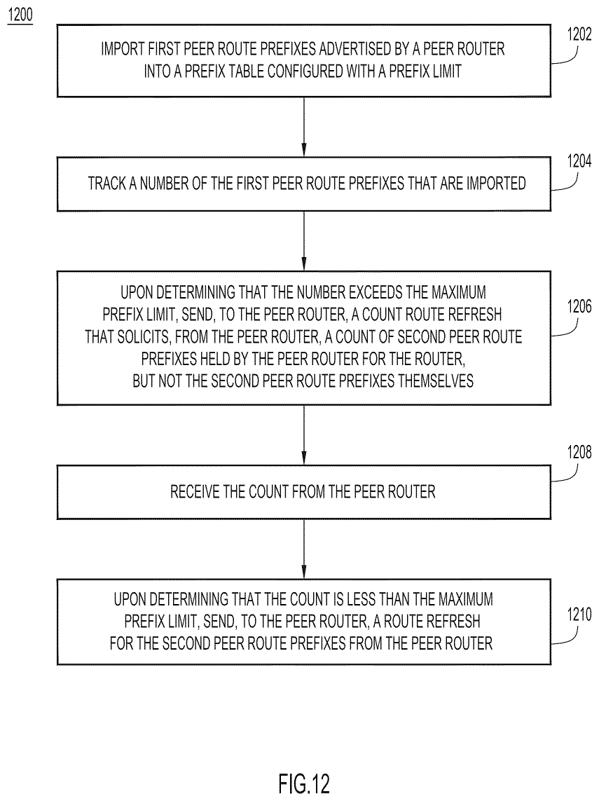

FIG. 12 is a flowchart of an example method 1200 of BGP auto-recovery performed by/between a router and peer router using the count route refresh. The router and the peer router are configured to implement the BGP across one or more networks. Method 1200 is implemented according to the first embodiment.

At 1202, the router imports first peer route prefixes advertised by the peer router into a prefix table configured with a prefix limit.

At 1204, the router tracks a number of the first peer route prefixes that are imported.

Upon determining that the number exceeds the prefix limit, at 1206, the router sends, to the peer router, a count route refresh that solicits, from the peer router, a count of second peer route prefixes held by the peer router (e.g., in a BGP table of the peer router) for the router, but not the second peer route prefixes themselves. There may be overlap between the first peer route prefixes and the second peer route prefixes.

At 1208, the router receives from the peer router only the count, but not the second peer route prefixes themselves.

Upon determining that the count is less than the prefix limit, at 1210, the router sends, to the peer router, a route refresh for the peer route prefixes. Upon receiving the peer route prefixes responsive to sending the route refresh, the router imports the peer route prefixes.

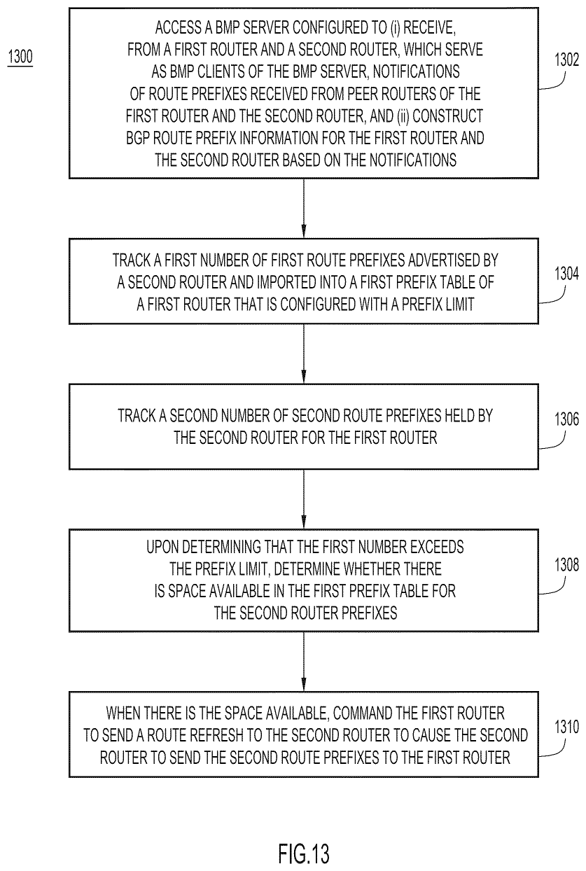

FIG. 13 is a flowchart of an example method 1300 of BGP auto-recovery performed by a network controller configured to control a first router and a second router that operate as routing peers (e.g., also as BGP peers) in one or more networks, and as BMP clients to a BMP server accessible to the network controller. Method 1300 is implemented according to the second embodiment.

At 1302, the network controller accesses the BMP server, which is configured to (i) receive, from the first router and the second router serving as the BMP clients to the BMP server, notifications of route prefixes received from peer routers, and (ii) construct BGP (route) prefix information for the first router and the second router based on the notifications.

Based on the BGP prefix information, at 1304, the network controller tracks a first number of first route prefixes advertised by the second router and imported into a first prefix table of the first router that is configured with a prefix limit.

Based on the BGP prefix information, at 1306, the network controller tracks a second number of second route prefixes held by the second router for the first router.

Upon determining that the first number exceeds the prefix limit, at 1308, the network controller determines whether there is space available in the first prefix table for the second route prefixes. To determine whether there is space available, the network controller computes a difference between the prefix limit and the first number of first route prefixes, and determines that there is the space available when the difference exceeds the second number of second route prefixes.

When there is the space available, at 1310, the network controller commands the first router to send a route refresh to the second router, to cause the second router to send the second route prefixes to the first router. Upon receiving the second route prefixes responsive to sending the route refresh, the first router imports the second route prefixes.

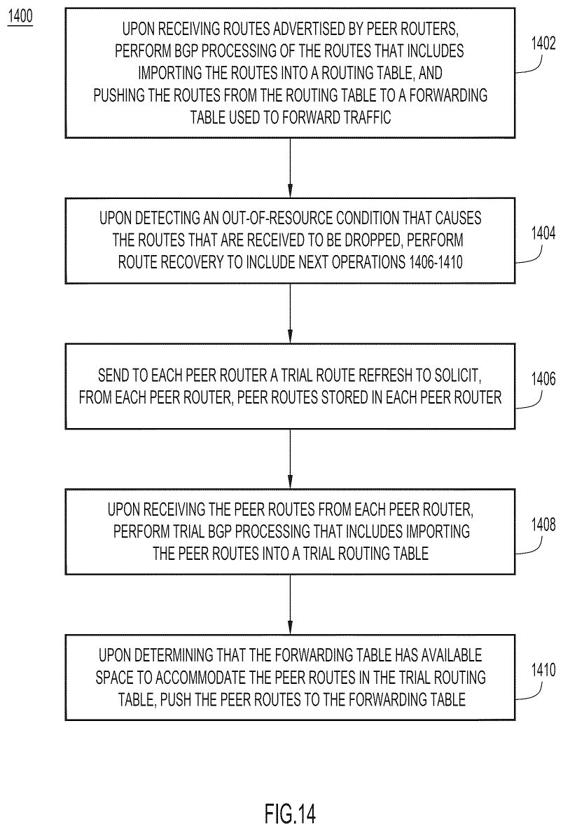

FIG. 14 is a flowchart of an example method 1400 performed by a router to implement OOR auto-recovery. Method 1400 is implemented according to the third embodiment.

Upon receiving routes (e.g., route prefixes) advertised by peer routers, at 1402, the router performs BGP processing of the routes. The BGP processing includes importing the routes into a routing table (e.g., a BGP table), and pushing the routes from the routing table to a forwarding table (e.g., an FIB) used to forward traffic.

Upon detecting an OOR condition that cause the routes that are received to be dropped, at 1404, the router performs the OOR auto-recovery. The OOR auto-recovery includes next operations 1406-1410, described below.

At 1406, the router sends to each peer router a trial route refresh to solicit peer routes stored in each peer router.

Upon receiving the peer routes from each peer router, at 1408, the router performs trial BGP processing that includes importing the peer routes into a trial routing table (which is not the routing table).

Upon determining that the forwarding table has available space to accommodate the peer routes in the trial routing table, at 1410, the router pushes the peer routes into the forwarding table (i.e., stores copies of the peer routes in the forwarding table).

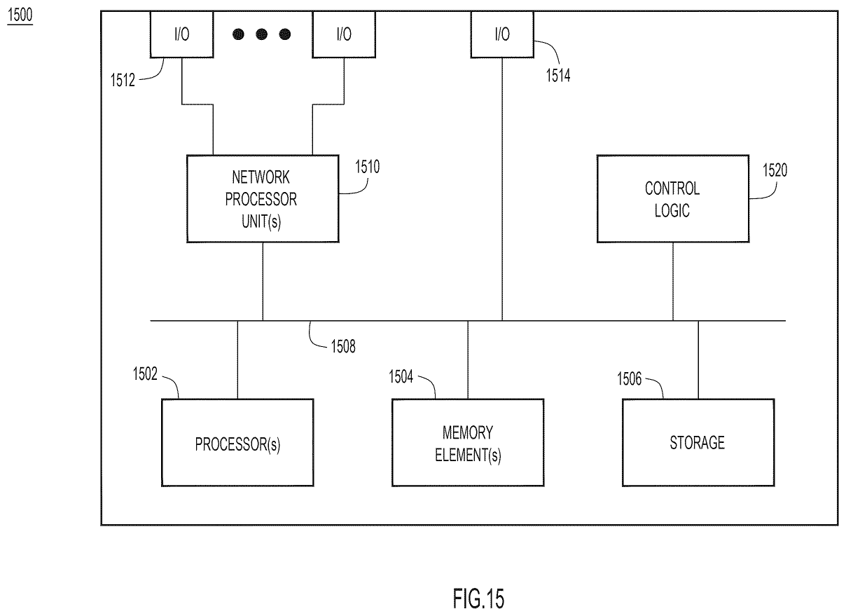

Referring to FIG. 15, FIG. 15 illustrates a hardware block diagram of a computing device 1500 that may perform functions associated with operations discussed herein in connection with the techniques depicted in FIGS. 1-14. In various embodiments, a computing device or apparatus, such as computing device 1500 or any combination of computing devices 1500, may be configured as any entity/entities as discussed for the techniques depicted in connection with FIGS. 1-14 in order to perform operations of the various techniques discussed herein. For example, computing device 1500 may represent a network device, such as a router, a network controller, and a BMP server.

In at least one embodiment, the computing device 1500 may be any apparatus that may include one or more processor(s) 1502, one or more memory element(s) 1504, storage 1506, a bus 1508, one or more network processor unit(s) 1510 interconnected with one or more network input/output (I/O) interface(s) 1512, one or more I/O interface(s) 1514, and control logic 1520. In various embodiments, instructions associated with logic for computing device 1500 can overlap in any manner and are not limited to the specific allocation of instructions and/or operations described herein.

In at least one embodiment, processor(s) 1502 is/are at least one hardware processor configured to execute various tasks, operations and/or functions for computing device 1500 as described herein according to software and/or instructions configured for computing device 1500. Processor(s) 1502 (e.g., a hardware processor) can execute any type of instructions associated with data to achieve the operations detailed herein. In one example, processor(s) 1502 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 1504 and/or storage 1506 is/are configured to store data, information, software, and/or instructions associated with computing device 1500, and/or logic configured for memory element(s) 1504 and/or storage 1506. For example, any logic described herein (e.g., control logic 1520) can, in various embodiments, be stored for computing device 1500 using any combination of memory element(s) 1504 and/or storage 1506. Note that in some embodiments, storage 1506 can be consolidated with memory element(s) 1504 (or vice versa), or can overlap/exist in any other suitable manner.

In at least one embodiment, bus 1508 can be configured as an interface that enables one or more elements of computing device 1500 to communicate in order to exchange information and/or data. Bus 1508 can be implemented with any architecture designed for passing control, data and/or information between processors, memory elements/storage, peripheral devices, and/or any other hardware and/or software components that may be configured for computing device 1500. In at least one embodiment, bus 1508 may be implemented as a fast kernel-hosted interconnect, potentially using shared memory between processes (e.g., logic), which can enable efficient communication paths between the processes.

In various embodiments, network processor unit(s) 1510 may enable communication between computing device 1500 and other systems, entities, etc., via network I/O interface(s) 1512 (wired and/or wireless) to facilitate operations discussed for various embodiments described herein. In various embodiments, network processor unit(s) 1510 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between computing device 1500 and other systems, entities, etc. to facilitate operations for various embodiments described herein. In various embodiments, network I/O interface(s) 1512 can be configured as one or more Ethernet port(s), Fibre Channel ports, any other I/O port(s), and/or antenna(s)/antenna array(s) now known or hereafter developed. Thus, the network processor unit(s) 1510 and/or network I/O interface(s) 1512 may include suitable interfaces for receiving, transmitting, and/or otherwise communicating data and/or information in a network environment.

I/O interface(s) 1514 allow for input and output of data and/or information with other entities that may be connected to computing device 1500. For example, I/O interface(s) 1514 may provide a connection to external devices such as a keyboard, keypad, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

In various embodiments, control logic 1520 can include instructions that, when executed, cause processor(s) 1502 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 1520) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, any entity or apparatus as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 1504 and/or storage 1506 can store data, software, code, instructions (e.g., processor instructions), logic, parameters, combinations thereof, and/or the like used for operations described herein. This includes memory element(s) 1504 and/or storage 1506 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®, Wi-Fi7®, Wi-Fi8®, etc.), IEEE 802.16 (e.g., Worldwide Interoperability for Microwave Access (WiMAX)), Radio-Frequency Identification (RFID), Near Field Communication (NFC), Bluetooth™, mm. wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

In various example implementations, any entity or apparatus for various embodiments described herein can encompass network elements (which can include virtualized network elements, functions, etc.) such as, for example, network appliances, forwarders, routers, servers, switches, gateways, bridges, loadbalancers, firewalls, processors, modules, radio receivers/transmitters, or any other suitable device, component, element, or object operable to exchange information that facilitates or otherwise helps to facilitate various operations in a network environment as described for various embodiments herein. Note that with the examples provided herein, interaction may be described in terms of one, two, three, or four entities. However, this has been done for purposes of clarity, simplicity and example only. The examples provided should not limit the scope or inhibit the broad teachings of systems, networks, etc. described herein as potentially applied to a myriad of other architectures.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Each example embodiment disclosed herein has been included to present one or more different features. However, all disclosed example embodiments are designed to work together as part of a single larger system or method. This disclosure explicitly envisions compound embodiments that combine multiple previously-discussed features in different example embodiments into a single system or method.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

In some aspects, the techniques described herein relate to a method performed by a router configured to implement a Border Gateway Protocol (BGP) with a peer router across one or more networks, the method including: importing first peer route prefixes that are advertised by the peer router into a prefix table configured with a prefix limit; tracking a number of the first peer route prefixes that are imported; upon determining that the number exceeds the prefix limit, sending, to the peer router, a count route refresh that solicits, from the peer router a count of second peer route prefixes that are held by the peer router for the router, but not the second peer route prefixes themselves; receiving the count from the peer router; and upon determining that the count is less than the prefix limit, sending, to the peer router, a route refresh for the second peer route prefixes.

In some aspects, the techniques described herein relate to a method, further including: upon determining that the count is not less than the prefix limit, not sending the route refresh.

In some aspects, the techniques described herein relate to a method, further including: waiting a timeout period between determining that the number exceeds the prefix limit and sending the count route refresh.

In some aspects, the techniques described herein relate to a method, further including: upon determining that the count exceeds the prefix limit, installing a restrictive inbound policy configured to remove from the router previously imported non-critical prefixes that are not in a critical prefix range and then import only critical route prefixes that are in the critical prefix range from the peer router.

In some aspects, the techniques described herein relate to a method, further including: upon determining that the count is less than the prefix limit, before sending the route refresh, removing the restrictive inbound policy.

In some aspects, the techniques described herein relate to a method, wherein the router and the peer router include autonomous system border routers that implement exterior-BGP.

In some aspects, the techniques described herein relate to a method, wherein the count route refresh includes an indicator of the count route refresh, an address family identifier, and a subsequent address family identifier.

In some aspects, the techniques described herein relate to a method, wherein: importing includes importing the first peer route prefixes that are advertised into a routing information base of the router.

In some aspects, the techniques described herein relate to a method, further including: upon receiving the second peer route prefixes that are sent by the peer router responsive to the count route refresh, importing the second peer route prefixes that are sent.

In some aspects, the techniques described herein relate to an apparatus including: a network interface unit configured to communicate with a network; and a processor of a router configured to implement a Border Gateway Protocol (BGP) with a peer router, wherein the processor is coupled to the network interface unit and configured to perform: importing first peer route prefixes that are advertised by the peer router into a prefix table configured with a prefix limit; tracking a number of the first peer route prefixes that are imported; upon determining that the number exceeds the prefix limit, sending, to the peer router, a count route refresh that solicits, from the peer router a count of second peer route prefixes that are held by the peer router for the router, but not the second peer route prefixes themselves; receiving the count from the peer router; and upon determining that the count is less than the prefix limit, sending, to the peer router, a route refresh for the second peer route prefixes.

In some aspects, the techniques described herein relate to an apparatus, wherein the processor is further configured to perform: upon determining that the count is not less than the prefix limit, not sending the route refresh.

In some aspects, the techniques described herein relate to an apparatus, wherein the processor is further configured to perform: waiting a timeout period between determining that the number exceeds the prefix limit and sending the count route refresh.

In some aspects, the techniques described herein relate to an apparatus, wherein the processor is further configured to perform: upon determining that the count exceeds the prefix limit, installing a restrictive inbound policy configured to remove from the router previously imported non-critical prefixes that are not in a critical prefix range and then import only critical route prefixes that are in the critical prefix range from the peer router.

In some aspects, the techniques described herein relate to an apparatus, wherein the processor is further configured to perform: upon determining that the count is less than the prefix limit, before sending the route refresh, removing the restrictive inbound policy.

In some aspects, the techniques described herein relate to an apparatus, wherein the processor is further configured to perform: upon receiving the second peer route prefixes that are sent by the peer router responsive to the count route refresh, importing the second peer route prefixes that are sent.

In some aspects, the techniques described herein relate to a non-transitory computer readable medium encoded with instructions that, when executed by a processor of a router configured to implement a Border Gateway Protocol (BGP) with a peer router across one or more networks, cause the processor to perform: importing first peer route prefixes that are advertised by the peer router into a prefix table configured with a prefix limit; tracking a number of the first peer route prefixes that are imported; upon determining that the number exceeds the prefix limit, sending, to the peer router, a count route refresh that solicits, from the peer router a count of second peer route prefixes that are held by the peer router for the router, but not the second peer route prefixes themselves; receiving the count from the peer router; and upon determining that the count is less than the prefix limit, sending, to the peer router, a route refresh for the second peer route prefixes.

In some aspects, the techniques described herein relate to a non-transitory computer readable medium, further including: upon determining that the count is not less than the prefix limit, not sending the route refresh.

In some aspects, the techniques described herein relate to a non-transitory computer readable medium, further including: waiting a timeout period between determining that the number exceeds the prefix limit and sending the count route refresh.

In some aspects, the techniques described herein relate to a non-transitory computer readable medium, further including: upon determining that the count exceeds the prefix limit, installing a restrictive inbound policy configured to remove from the router previously imported non-critical prefixes that are not in a critical prefix range and then import only critical route prefixes that are in the critical prefix range from the peer router.

In some aspects, the techniques described herein relate to a non-transitory computer readable medium, further including: upon determining that the count is less than the prefix limit, before sending the route refresh, removing the restrictive inbound policy.

In some aspects, the techniques described herein relate to a method performed by a network controller of a first router and a second router that operate as routing peers in one or more networks, the method including: tracking a first number of first route prefixes advertised by the second router and imported into a first prefix table of the first router and that is configured with a prefix limit; tracking a second number of second route prefixes held by the second router for the first router; upon determining that the first number of first route prefixes exceeds the prefix limit, determining whether there is space available in the first prefix table for the second route prefixes; and when there is the space available, commanding the first router to send a route refresh to the second router to cause the second router to send the second route prefixes to the first router.

In some aspects, the techniques described herein relate to a method, wherein determining whether there is the space available includes: computing a difference between the prefix limit and the first number of first route prefixes; and determining that there is the space available when the difference exceeds the second number of second route prefixes.

In some aspects, the techniques described herein relate to a method, wherein determining whether there is the space available further includes: determining that there is not the space available when the difference does not exceed the second number of second route prefixes.

In some aspects, the techniques described herein relate to a method, further including: when there is not the space available, not commanding the first router to send the route refresh.

In some aspects, the techniques described herein relate to a method, further including: waiting a timeout period between determining that the first number of first route prefixes exceeds the prefix limit and determining whether there is the space available.

In some aspects, the techniques described herein relate to a method, further including: upon determining that the first number of first route prefixes exceeds the prefix limit, commanding the first router to install a restrictive inbound policy configured to cause the first router to remove from the first router previously imported non-critical prefixes that are not in a critical prefix range and then import only critical route prefixes that are in the critical prefix range from the second router.

In some aspects, the techniques described herein relate to a method, further including: upon determining that there is the space available, before commanding the first router to send the route refresh, removing the restrictive inbound policy.

In some aspects, the techniques described herein relate to a method, further including: upon determining that the first number of first route prefixes exceeds the prefix limit, commanding the second router to install a restrictive outbound policy configured to cause the second router to advertise only critical route prefixes in a critical prefix range to the first router.

In some aspects, the techniques described herein relate to a method, further including: accessing a BGP monitoring protocol (BMP) server configured to receive, from the first router and the second router configured as BMP clients, notifications of route prefixes received from peer routers of the BMP clients, and construct BGP route prefix information for the first router and the second router based on the notifications, and wherein tracking the first number of first route prefixes includes tracking the first number of first route prefixes based on the BGP route prefix information, wherein tracking the second number of second route prefixes includes tracking the second number of second route prefixes based on the BGP route prefix information.

In some aspects, the techniques described herein relate to an apparatus including: a network interface unit configured to communicate with a network; and a processor of a network controller configured to control a first router and a second router that operate as routing peers in one or more networks, wherein the network controller is coupled to the network interface unit and configured to perform: tracking a first number of first route prefixes advertised by the second router and imported into a first prefix table of the first router and that is configured with a prefix limit; tracking a second number of second route prefixes held by the second router for the first router; upon determining that the first number of first route prefixes exceeds the prefix limit, determining whether there is space available in the first prefix table for the second route prefixes; and when there is the space available, commanding the first router to send a route refresh to the second router to cause the second router to send the second route prefixes to the first router.

In some aspects, the techniques described herein relate to an apparatus, wherein the processor is configured to perform determining whether there is the space available by: computing a difference between the prefix limit and the first number of first route prefixes; and determining that there is the space available when the difference exceeds the second number of second route prefixes.

In some aspects, the techniques described herein relate to an apparatus, wherein the processor is further configured to perform determining whether there is the space available further by: determining that there is not the space available when the difference does not exceed the second number of second route prefixes.

In some aspects, the techniques described herein relate to an apparatus, wherein the processor is further configured to perform: when there is not the space available, not commanding the first router to send the route refresh.

In some aspects, the techniques described herein relate to an apparatus, wherein the processor is further configured to perform: waiting a timeout period between determining that the first number of first route prefixes exceeds the prefix limit and determining whether there is the space available.

In some aspects, the techniques described herein relate to an apparatus, wherein the processor is further configured to perform: upon determining that the first number of first route prefixes exceeds the prefix limit, commanding the first router to install a restrictive inbound policy configured to cause the first router to remove from the first router previously imported non-critical prefixes that are not in a critical prefix range and then import only critical route prefixes that are in the critical prefix range from the second router.

In some aspects, the techniques described herein relate to an apparatus, wherein the processor is further configured to perform: upon determining that there is the space available, before commanding the first router to send the route refresh, removing the restrictive inbound policy.

In some aspects, the techniques described herein relate to an apparatus, wherein the processor is further configured to perform: accessing a BGP monitoring protocol (BMP) server configured to receive, from the first router and the second router configured as BMP clients, notifications of route prefixes received from peer routers of the BMP clients, and construct BGP route prefix information for the first router and the second router based on the notifications, and wherein the processor is configured to perform tracking the first number of first route prefixes by tracking the first number of first route prefixes based on the BGP route prefix information, wherein the processor is configured to perform tracking the second number of second route prefixes by tracking the second number of second route prefixes based on the BGP route prefix information.

In some aspects, the techniques described herein relate to a non-transitory computer readable medium encoded with instructions that, when executed by a processor of a network controller of a first router and a second router that operate as routing peers in one or more networks, cause the processor to perform: tracking a first number of first route prefixes advertised by the second router and imported into a first prefix table of the first router and that is configured with a prefix limit; tracking a second number of second route prefixes held by the second router for the first router; upon determining that the first number of first route prefixes exceeds the prefix limit, determining whether there is space available in the first prefix table for the second route prefixes; and when there is the space available, commanding the first router to send a route refresh to the second router to cause the second router to send the second route prefixes to the first router.

In some aspects, the techniques described herein relate to a non-transitory computer readable medium, wherein the instructions to cause the processor to perform determining whether there is the space available include instructions to cause the processor to perform: computing a difference between the prefix limit and the first number of first route prefixes; and determining that there is the space available when the difference exceeds the second number of second route prefixes.

In some aspects, the techniques described herein relate to a non-transitory computer readable medium, wherein the instructions to cause the processor to perform determining whether there is the space available further include instructions to cause the processor to perform: determining that there is not the space available when the difference does not exceed the second number of second route prefixes.

In some aspects, the techniques described herein relate to a method performed by a router in a network, the method including: upon receiving routes advertised by peer routers, performing route processing of the routes that includes importing the routes into a routing table, and pushing the routes from the routing table to a forwarding table used to forward traffic; and upon detecting an out-of-resource condition that cause the routes that are received to be dropped, performing route recovery to include: sending to each peer router a trial route refresh to solicit peer routes stored in each peer router; upon receiving the peer routes from each peer router, performing trial route processing that includes importing the peer routes into a trial routing table; and upon determining that the forwarding table has available space to accommodate the peer routes in the trial routing table, pushing the peer routes to the forwarding table.

In some aspects, the techniques described herein relate to a method, further including: upon determining that the forwarding table does not have the available space, not pushing the peer routes to the forwarding table.

In some aspects, the techniques described herein relate to a method, further including: upon determining that the forwarding table does not have the available space: waiting a timeout period; clearing the trial routing table; and performing the route recovery.

In some aspects, the techniques described herein relate to a method, wherein: detecting includes detecting that the route processing has reached a memory limit or that the available space in the forwarding table has fallen below a threshold.

In some aspects, the techniques described herein relate to a method, wherein: determining that the forwarding table has the available space includes: tracking the available space in the forwarding table and a size of the trial routing table; and determining that the forwarding table has the available space when the available space is greater than or equal to the size of the trial routing table.

In some aspects, the techniques described herein relate to a method, further including: determining that the forwarding table does not have the available space when the available space is not greater than or equal to the size of the trial routing table.

In some aspects, the techniques described herein relate to a method, wherein: the trial route refresh is configured to cause each peer router that receives the trial route refresh to periodically send, to the router, batches of the peer routes, from a respective routing table at each peer router, at spaced-apart time intervals.

In some aspects, the techniques described herein relate to a method, wherein: the route processing includes Border Gateway Protocol (BGP) processing, and the routes include Internet Protocol (IP) prefixes.

In some aspects, the techniques described herein relate to an apparatus including: a network interface unit configured to communicate with a network; and a processor of a router, wherein the processor is coupled to the network interface unit and configured to perform: upon receiving routes advertised by peer routers, performing route processing of the routes that includes importing the routes into a routing table, and pushing the routes from the routing table to a forwarding table used to forward traffic; and upon detecting an out-of-resource condition that cause the routes that are received to be dropped, performing route recovery to include: sending to each peer router a trial route refresh to solicit peer routes stored in each peer router; upon receiving the peer routes from each peer router, performing trial route processing that includes importing the peer routes into a trial routing table; and upon determining that the forwarding table has available space to accommodate the peer routes in the trial routing table, pushing the peer routes to the forwarding table.

In some aspects, the techniques described herein relate to an apparatus, wherein the processor is further configured to perform: upon determining that the forwarding table does not have the available space, not pushing the peer routes to the forwarding table.

In some aspects, the techniques described herein relate to an apparatus, wherein the processor is further configured to perform, upon determining that the forwarding table does not have the available space: waiting a timeout period; clearing the trial routing table; and performing the route recovery.

In some aspects, the techniques described herein relate to an apparatus, wherein: the processor is configured to perform detecting by detecting that the route processing has reached a memory limit or that the available space in the forwarding table has fallen below a threshold.

In some aspects, the techniques described herein relate to an apparatus, wherein the processor is configured to perform determining that the forwarding table has the available space by: tracking the available space in the forwarding table and a size of the trial routing table; and determining that the forwarding table has the available space when the available space is greater than or equal to the size of the trial routing table.

In some aspects, the techniques described herein relate to an apparatus, wherein the processor is further configured to perform: determining that the forwarding table does not have the available space when the available space is not greater than or equal to the size of the trial routing table.

In some aspects, the techniques described herein relate to an apparatus, wherein: the trial route refresh is configured to cause each peer router that receives the trial route refresh to periodically send, to the router, batches of the peer routes, from a respective routing table at each peer router, at spaced-apart time intervals.

In some aspects, the techniques described herein relate to an apparatus, wherein: the route processing includes Border Gateway Protocol (BGP) processing, and the routes include Internet Protocol (IP) prefixes.

In some aspects, the techniques described herein relate to a non-transitory computer readable medium encoded with instructions that, when executed by a processor of a router in a network, cause the processor to perform: upon receiving routes advertised by peer routers, performing route processing of the routes that includes importing the routes into a routing table, and pushing the routes from the routing table to a forwarding table used to forward traffic; and upon detecting an out-of-resource condition that cause the routes that are received to be dropped, performing route recovery to include: sending to each peer router a trial route refresh to solicit peer routes stored in each peer router; upon receiving the peer routes from each peer router, performing trial route processing that includes importing the peer routes into a trial routing table; and upon determining that the forwarding table has available space to accommodate the peer routes in the trial routing table, pushing the peer routes to the forwarding table.

In some aspects, the techniques described herein relate to a non-transitory computer readable medium, further including instructions to cause the processor to perform: upon determining that the forwarding table does not have the available space, not pushing the peer routes to the forwarding table.

In some aspects, the techniques described herein relate to a non-transitory computer readable medium, further including instructions to cause the processor to perform: upon determining that the forwarding table does not have the available space: waiting a timeout period; clearing the trial routing table; and performing the route recovery.

In some aspects, the techniques described herein relate to a non-transitory computer readable medium, wherein: the instructions to cause the processor to perform detecting include instructions to cause the processor to perform detecting that the route processing has reached a memory limit or that the available space in the forwarding table has fallen below a threshold.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method performed by a router configured to implement a Border Gateway Protocol (BGP) with a peer router across one or more networks, the method comprising:
importing first peer route prefixes that are advertised by the peer router into a prefix table configured with a prefix limit;
tracking a number of the first peer route prefixes that are imported;
upon determining that the number exceeds the prefix limit, sending, to the peer router, a count route refresh that solicits, from the peer router a count of second peer route prefixes that are held by the peer router for the router, but not the second peer route prefixes themselves;
receiving the count from the peer router; and
upon determining that the count is less than the prefix limit, sending, to the peer router, a route refresh for the second peer route prefixes.

2. The method of claim 1, further comprising:
upon determining that the count is not less than the prefix limit, not sending the route refresh.

3. The method of claim 1, further comprising:
waiting a timeout period between determining that the number exceeds the prefix limit and sending the count route refresh.

4. The method of claim 1, further comprising:
upon determining that the count exceeds the prefix limit, installing a restrictive inbound policy configured to remove from the router previously imported non-critical prefixes that are not in a critical prefix range and then import only critical route prefixes that are in the critical prefix range from the peer router.

5. The method of claim 4, further comprising:
upon determining that the count is less than the prefix limit, before sending the route refresh, removing the restrictive inbound policy.

6. The method of claim 1, wherein the router and the peer router include autonomous system border routers that implement exterior-BGP.

7. The method of claim 1, wherein the count route refresh includes an indicator of the count route refresh, an address family identifier, and a subsequent address family identifier.

8. The method of claim 1, wherein:
importing includes importing the first peer route prefixes that are advertised into a routing information base of the router.

9. The method of claim 1, further comprising:
upon receiving the second peer route prefixes that are sent by the peer router responsive to the count route refresh, importing the second peer route prefixes that are sent.

10. An apparatus comprising:
a network interface unit configured to communicate with a network; and
a processor of a router configured to implement a Border Gateway Protocol (BGP) with a peer router, wherein the processor is coupled to the network interface unit and configured to perform:
importing first peer route prefixes that are advertised by the peer router into a prefix table configured with a prefix limit;
tracking a number of the first peer route prefixes that are imported;
upon determining that the number exceeds the prefix limit, sending, to the peer router, a count route refresh that solicits, from the peer router a count of second peer route prefixes that are held by the peer router for the router, but not the second peer route prefixes themselves;
receiving the count from the peer router; and
upon determining that the count is less than the prefix limit, sending, to the peer router, a route refresh for the second peer route prefixes.

11. The apparatus of claim 10, wherein the processor is further configured to perform:
upon determining that the count is not less than the prefix limit, not sending the route refresh.

12. The apparatus of claim 10, wherein the processor is further configured to perform:
waiting a timeout period between determining that the number exceeds the prefix limit and sending the count route refresh.

13. The apparatus of claim 10, wherein the processor is further configured to perform:
upon determining that the count exceeds the prefix limit, installing a restrictive inbound policy configured to remove from the router previously imported non-critical prefixes that are not in a critical prefix range and then import only critical route prefixes that are in the critical prefix range from the peer router.

14. The apparatus of claim 13, wherein the processor is further configured to perform:
upon determining that the count is less than the prefix limit, before sending the route refresh, removing the restrictive inbound policy.

15. The apparatus of claim 10, wherein the processor is further configured to perform:
upon receiving the second peer route prefixes that are sent by the peer router responsive to the count route refresh, importing the second peer route prefixes that are sent.

16. A non-transitory computer readable medium encoded with instructions that, when executed by a processor of a router configured to implement a Border Gateway Protocol (BGP) with a peer router across one or more networks, cause the processor to perform:
importing first peer route prefixes that are advertised by the peer router into a prefix table configured with a prefix limit;
tracking a number of the first peer route prefixes that are imported;
upon determining that the number exceeds the prefix limit, sending, to the peer router, a count route refresh that solicits, from the peer router a count of second peer route prefixes that are held by the peer router for the router, but not the second peer route prefixes themselves;
receiving the count from the peer router; and
upon determining that the count is less than the prefix limit, sending, to the peer router, a route refresh for the second peer route prefixes.

17. The non-transitory computer readable medium of claim 16, further comprising:
upon determining that the count is not less than the prefix limit, not sending the route refresh.

18. The non-transitory computer readable medium of claim 16, further comprising:
waiting a timeout period between determining that the number exceeds the prefix limit and sending the count route refresh.

19. The non-transitory computer readable medium of claim 16, further comprising:
upon determining that the count exceeds the prefix limit, installing a restrictive inbound policy configured to remove from the router previously imported non-critical prefixes that are not in a critical prefix range and then import only critical route prefixes that are in the critical prefix range from the peer router.

20. The non-transitory computer readable medium of claim 19, further comprising:
upon determining that the count is less than the prefix limit, before sending the route refresh, removing the restrictive inbound policy.
